(19) United States
(12) Patent Application Publication
(10) Pub. No.: US 2019/0371146 A1
(43) Pub. Date: Dec. 5, 2019

(54) Burglary deterrent solution

(71) Applicant: DSP Group Ltd., Herzliya (IL)

(72) Inventors: Michael Gollnick, Wilhermsdorf (DE); Haim Kuperschmidt, OR YEHUDA (IL)

(21) Appl. No.: 16/409,871

(22) Filed: May 13, 2019

Related U.S. Application Data
(60) Provisional application No. 62/678,290, filed on May 31, 2018.

(51) Int. Cl. G08B 15/00; G10L 15/00

(52) U.S. Cl. CPC G08B 15/00; G10L 15/005

(57) ABSTRACT

A method for burglary deterrent, the method may include receiving or generating suspected burglary information regarding a suspected burglary; selecting, by a computerized system, out of multiple burglary deterrent responses that differ from each other, a selected burglary deterrent response that comprises generating at least one deterring human perceivable signal; and executing the selected burglary response, wherein the executing comprises generating the at least one human perceivable signal.

### CROSS REFERENCE

This application claims priority from U.S. provisional patent Ser. No. 62/678,290 filing date May 31, 2018.

### BACKGROUND

Burglaries may be very common despite the widespread of alarm systems.

There may be a growing need to provide an efficient burglary deterrent solution.

### SUMMARY

There may be provided a method for burglary deterrent, the method may include receiving or generating suspected burglary information regarding a suspected burglary; selecting, by a computerized system, out of multiple burglary deterrent responses that differ from each other, a selected burglary deterrent response that may include generating at least one deterring human perceivable signal; and executing the selected burglary response, wherein the executing may include generating the at least one human perceivable signal.

The suspected burglary information may include burglar information about a burglar that may be involved in the suspected burglary; and wherein the selecting may be responsive to the burglar information.

The selecting may be responsive to a gender of the burglar.

The executing of the selected burglary response may include generating at least one message that may include at least a part of the burglar information.

The executing of the selected burglary response may include interacting with the burglar.

The method may include sensing a response of the burglar to the at least one human perceivable signal; and selecting another selected burglary deterrent response based on the response of the burglar.

The executing of the selected burglary response may include generating messages in different languages.

The method may include monitoring a response of the burglar to the messages in different languages; estimating which language of the multiple languages may be understood by the burglar; and generating additional messages at the language that may be understood by the burglar.

The executing of the selected burglary response may include interrogating the burglar.

The executing of the selected burglary response may include displaying, on a display, an image of the burglar.

The executing of the selected burglary response may include displaying, on a display, a video that shows a police car that approaches a location in which the suspected burglary occurs.

The executing of the selected burglary response may include notifying a person of interest about the suspected burglary.

The executing of the selected burglary response may include evaluating whether the burglar carries a weapon.

The selecting may be responsive to information regarding previous burglaries.

The executing the selected burglary response may include playing annoying music.

The method may include sensing one or more burglar attributes. This may include acquiring (by a camera or other image sensor) an image of the burglar or an image of a part of the burglar (for example face), determining a at least one out of height, weight, complexion, gate, gender of the burglar, sensing a speech of the burglar, generating a unique signature of the speech and the like, sharing the one or more burglar attributes with the police or any other third party. The one or more burglar attribute may be a part of the suspected burglary information.

The method may include storing the suspected burglary information in a remote computer—a computer not located in the location of the suspected burglary.

There may be provided a non-transitory computer program product that stores instructions for: receiving or generating suspected burglary information regarding a suspected burglary; selecting, by a computerized system, out of multiple burglary deterrent responses that differ from each other, a selected burglary deterrent response that may include generating at least one deterring human perceivable signal; and executing the selected burglary response, wherein the executing may include generating the at least one human perceivable signal.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1A illustrates an example of a method;

FIG. 1B illustrates an example of a method;

FIG. 2 illustrates an example of a building, various devices, a network and a system;

FIG. 3 illustrates an example of a building, various devices, a network and a system;

FIG. 4 illustrates an example of a building, various devices, a network and a system; and

FIG. 5 illustrates an example of a building, various devices, a network and a system.

### DETAILED DESCRIPTION OF THE DRAWINGS

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

There may be provided a system, a method and a non-transitory computer program product for burglary deterrent. The system is also referred to as a computerized system.

The system may include input devices or may interact with input devices that obtain audio and/or visual signals from one or more places within a certain location that is protected by the system. The certain location may be a building, a part of a building, an open space, a pool, a garden, and the like.

The input devices may be fixed, may be mobile, may belong to the building or may belong to a user. An input device may be a microphone, an array of microphones, a smartphone, a camera, an infrared (IR) sensor, a heat sensor, a vibration sensor, and the like.

The system may include output devices or may interact with output devices that output audio signals.

The system may include output devices or may interact with output devices that output video signals.

An output device may be one or more speakers, a smartphone, a video screen, a smart television, a non-smart television, a computer screen, a tablet and the like.

At least one device may function as an output device and an input device.

The system may include one or more computers and/or may interact with one or more local computers and/or remote computers. A local computer is located within the location that is being monitored. A remote computer is located outside the location that is being monitored.

The input devices and/or the output devices may include, for example, mobile communication devices (such as but not limited to smartphones), teleconference devices, microphones, cameras, displays, televisions, and the like.

The input devices and/or the output devices may communicate directly or indirectly with the system using one or more types of communication links such as wireless links (cellular, ZigBee, Wi-Fi, and the like), wired links and the like.

The input devices and/or the output devices may include one or more dedicated devices with microphone and speaker. A dedicated device is dedicated to burglary deterrence.

The input devices and/or the output devices may be small (for example length of less than 5, 10, 20 centimeter) and hard to spot (concealed, partially concealed), may be battery-operated or not. An output device may include any smart speaker or mobile phone within the certain location.

The output devices may be activated (by the one or more computers) on demand when detecting that a burglar enters the certain location.

The one or more computers of the system may include a local computer (located at the certain location or near the certain location) that may interact with a remote computer (such as a cloud computer. Each computer may include at least one processing circuits. Each processing circuit may include at least a part of at least one integrated circuit, may include one or more other hardware components as well as one of more software or firmware components. A processing circuit may be a CPU, a GPU, an ASIC, an FPGA, a hardware accelerator, a controller, a microcontroller, and the like.

Input devices and/or the output devices and/or a local computer located in the certain location may be concealed.

The one or more computers may provide a software as a service that may be reachable through some network and may be programmed to perform voice analysis (of voice obtained from the one or more input devices) and create interrogations/sounds (to be outputted by the one or more output devices) based on the voice analysis and optionally on knowledge from a database.

The system may store and/or may retrieve knowledge about best deterrent methods which may be adapted based on voice, language, region and the like.

A local hidden storage unit may keep an emergency copy of the database.

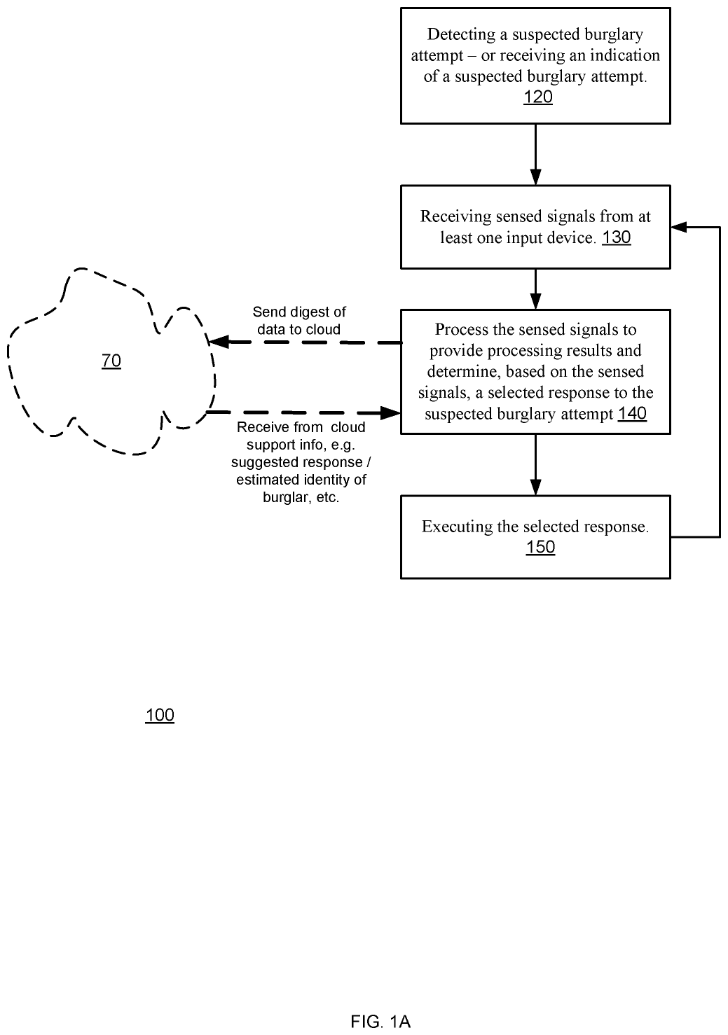

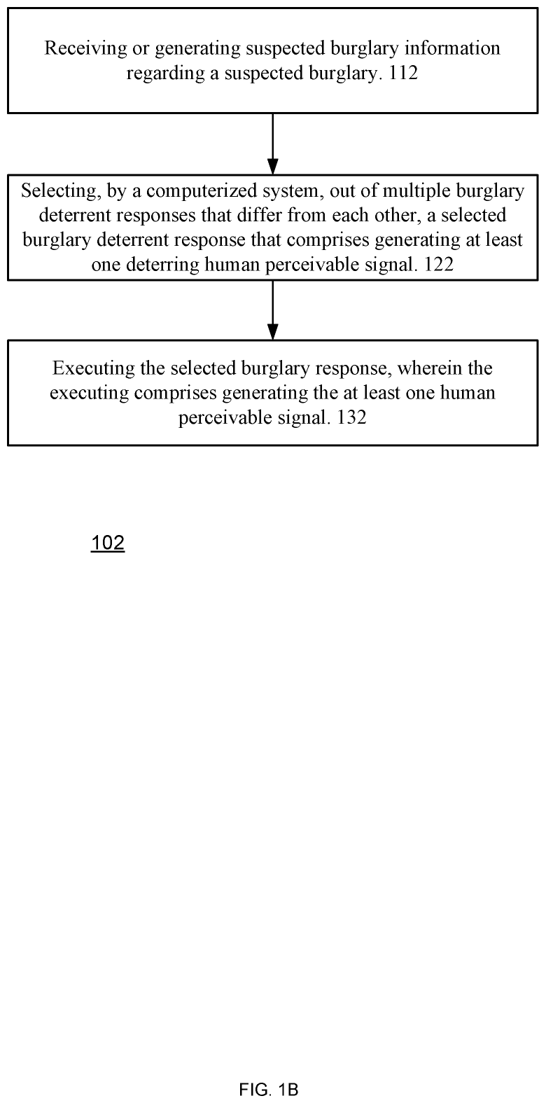

FIG. 1A illustrates an example of method 100.

Method 100 may include steps 120, 130, 140 and 150.

Step 120 may include detecting a suspected burglary attempt—or receiving an indication of a suspected burglary attempt.

Step 130 may include receiving sensed signals from at least one input device. The sensed signals may be audio signals and/or video signals. The signals may be sensed before step 120—as the detection of the suspected burglary attempt may be based on an analysis of sensed signals. It should be noted that the detection of the suspected burglary attempt may be based on any other method.

The sensed signals may be locally stored and/or transmitted to a remote location.

Step 140 may include processing the sensed signals to provide processing results and determine, based on the sensed signals, a selected response to the suspected burglary attempt. Step 140 may be done by a local computer and/or by a remote computer that is coupled via a network (such as 70) to the local devices.

The selected response may be based on reactions by the burglar or solely on knowledge from the database. Such sounds or interrogations may be rhetorical questions related to burglary and its consequences, threats, jokes, loud music, shouting's in foreign languages and the like.

These may be played back in different languages (based on detected features such as the language), accent, accentuation, modulation of the speech such as the pitch and the like. If the system detects a response by the burglar by detecting speech or sounds during its own sound generation additional interrogations may be applied such as misunderstanding on purpose and call backs. All described sounds or interrogations may be applied in any order and may be repeated.

The database may hold a variety of such responses precomputed, is an expert system or is able to interact like a speech assistant to form questions and answers dynamically.

Feedback of the burglary might be collected to further improve the database, expert system or the speech assistant.

There may be provided an expert system that is constructed to be a collection of best deterrent methods like e.g. what can be regarded as an annoying music, a sound that will slow down most of the people on concentrating or holds a big database of rhetorical questions to pester the burglar. On top of that it can hold rules that connect detected features like language, age, sex and the like to other rules like to speak in another language, tell jokes, threat the burglar or just pretend to misunderstand any word it hears.

The selection may be based on processing results—especially burglar parameters such as such as the age of the burglar, the gender of the burglar, the specific characteristic features such as gate, height, face features, accent, color of skin and hair, and the like. The knowledge base may include responses that are tailored to the burglar parameters.

The knowledge base may be an expert system with a growing number of rules created by burglary experts, psychologists, policemen and the like from which the system can choose randomly or based on previous burglary attempts.

Step 150 may include executing the selected response.

Multiple iteration of steps 120, 130, 140 and 150 may be executed. Thus—the system may interact with the burglar—and may perform multiple iterations of sensing signals, analyzing the signals and responding. These iterations may enable the system to adjust its response—especially based on what seem to be a success or failure of previous responses. A success may be represented by a delay in the progress of the burglary, having the burglar respond to the output signals from the system, and the like.

Step 150 may include outputting audio and/or video signals.

Examples of step 150 may include attempting to interact with the burglar, generating output signals that may be tailored to defer or deter the burglar, and the like.

For example—step 150 may include at least one out of:
a. Turning on a screen of available video capable output devices and showing the burglar a photo of the burglar that was acquired by an input device such as a camera.
b. Outputting deterring messages such as “You have been caught by on-site security camera” . . . “You can and will be identified by your features”.
c. Display a video of police car approaching to the premises.
d. Inform the burglar that “Police is on the way here”
e. Outputting different voice schemes to create a deterring psychological effect.
f. Operating in a wingman mode—provide a person of interest (such as the owner of the certain location and/or any person authorized to use the certain location) with real time information about any burglar parameter and even the weapons (if such exist) of the burglar. These parameters may be also outputted by one or more output devices—or may not be outputted by the one or more output devices. The real time information may assist the person of interest when taking protective measures.
g. Repeating step 120 throughout 150 may create pestering effect on the burglar.

The system may be a cloud based system that is configured to perform automatic interrogation/conversation, voice/video analysis and interact with a burglar.

The system may be configured to collect evidences (voice, security camera pictures, language, text).

The system may be configured to connect evidences with prior seen intrusion attempts (from the cloud). This may be used, for example, for police interrogation. This may be used for performing smarter interrogations with burglar to better pierce its mind (e.g. speak the right language, be offending, terrifying voices, annoying sounds, direct verbal approach).

The system may be configured to interact with the burglar and cause the burglar to
a. Give up (the burglary deterring steps may increase the stress of the burglar, may cause the burglar to think that the completion of the burglary will take too long.
b. Slow the burglar—so that the burglary will be completed on more time (more time for the police).
c. Do mistakes (leaves stuff, touches things, says something incriminating).

FIG. 1B illustrates an example of method 102.

Method 102 is for burglary deterrent and may include steps 112, 122, 132, 142

Step 112 may include receiving or generating suspected burglary information regarding a suspected burglary. The burglary information may be sensed by one of more input devices that monitor at least parts of the location of the suspected burglary. The burglary information may be an outcome of processing said sensed information. The burglary information may be generated based on feedback of third parties, and the like.

Step 122 may include selecting, by a computerized system, out of multiple burglary deterrent responses that differ from each other, a selected burglary deterrent response that comprises generating at least one deterring human perceivable signal.

At least one human perceivable signal is deterring in the sensed that it is either tested to be deterring, estimated to be deterring, or otherwise was proved to calculated to be deterring.

At least one deterring human perceivable signal may differ from a fixed siren sound.

Step 122 may include at least one out of:
a. Selecting in response to information regarding previous burglaries.
b. Selecting in response to the burglar information.
c. Selecting in response to a gender of the burglar

Step 132 may include executing the selected burglary response, wherein the executing comprises generating the at least one human perceivable signal.

The executing may include at least one out of:
a. Generating at least one message that may include at least a part of the burglar information. The message may be an audio message, a visual message or an audio-visual message. The message may be a textual message, an image, a video stream, and the like.
b. Interacting with the burglar.
c. Sensing a response of the burglar to the at least one human perceivable signal and jumping to step 122 of selecting another selected burglary deterrent response based on the response of the burglar.
d. Generating messages in different languages.
e. Monitoring a response of the burglar to the messages in different languages.
f. Estimating which language of the multiple languages is understood by the burglar.
g. Generating additional messages at the language that is understood by the burglar.
h. Interrogating the burglar.
i. Displaying, on a display, an image of the burglar.
j. Displaying, on a display, a video that shows a police car that approaches a location in which the suspected burglary occurs.
k. Notifying a person of interest about the suspected burglary.
l. Estimating, based on a response of the burglar, an effectiveness of step 132.
m. Evaluating whether the burglar carries a weapon. This may be executed by image processing of an image of the burglar.
n. Playing annoying music.

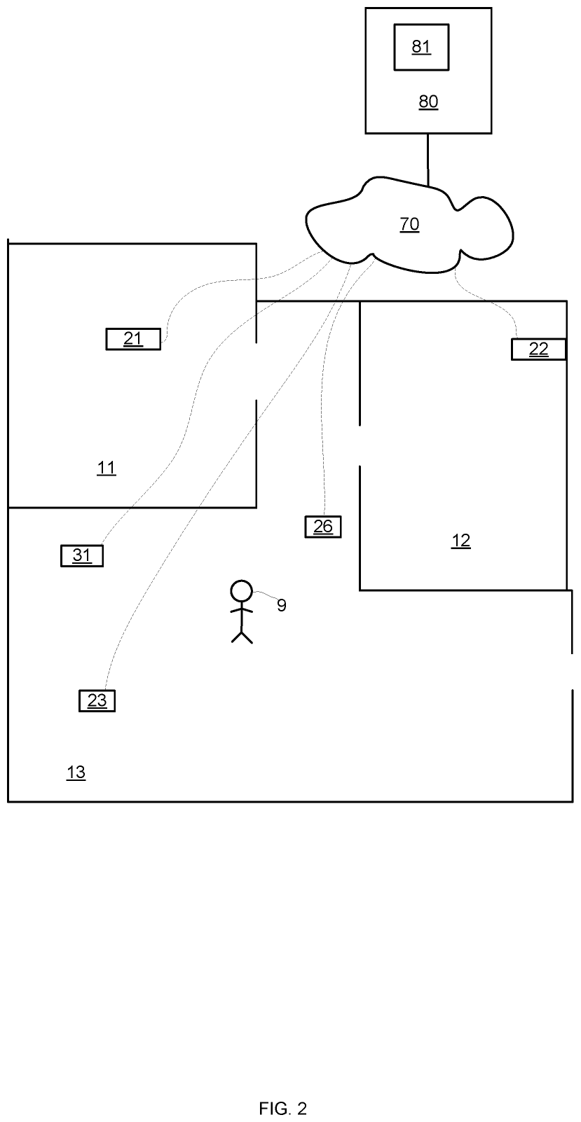

FIG. 2 illustrates an example of a building that includes rooms 11, 12 and 13, various devices, a network and a system.

Room 11 includes a teleconference device 21. Room 12 includes an audio sensing device such as microphone 22. Room 13 may be equipped with yet another input device 23 and output device 31. Device 26 may be an input or an output device.

Devices such as teleconference device 21, microphone 22, and any input device out of 23, 26 and 31 used to sense audio signals in rooms 11, 12 and room 13 respectively.

FIGS. 2-5 illustrate various examples of a system and a certain location.

FIG. 2 illustrates a system that does not include a local computer—but rather a remote computer 80 that is coupled via network 70 to various input devices 21, 22 and 23—and to output device 31. Remote computer 80 stores (or is coupled to a storage device that stores) knowledge database 81.

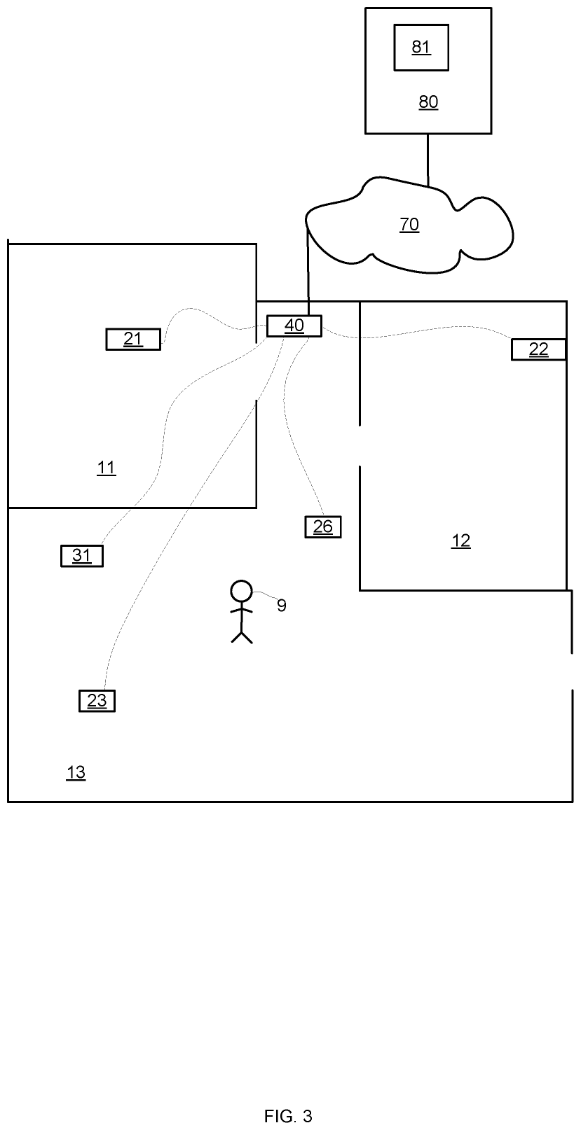

FIG. 3 illustrates a system that includes a local computer 40 that is coupled via network 70 to remote computer 80. Local computer 40 is coupled to various input devices 21, 22 and 23—and to output device 31. Remote computer 80 stores (or is coupled to a storage device that stores) knowledge database 81.

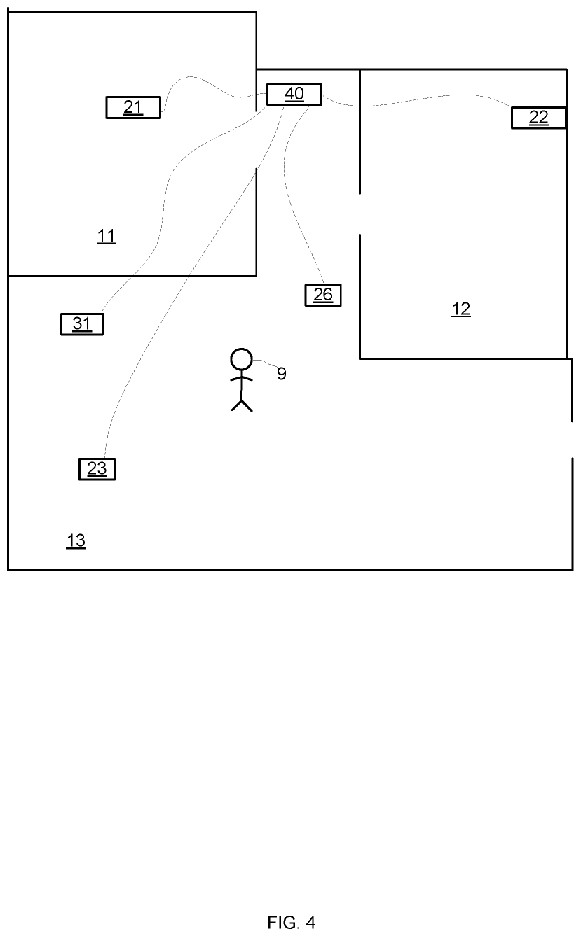

FIG. 4 illustrates a system that includes a local computer 40. The local computer may not be coupled to network 70 or to remote computer 80. Local computer 40 is coupled to various input devices 21, 22 and 23—and to output device 31. Local computer 40 may store (or is coupled to a storage device that stores) a knowledge database.

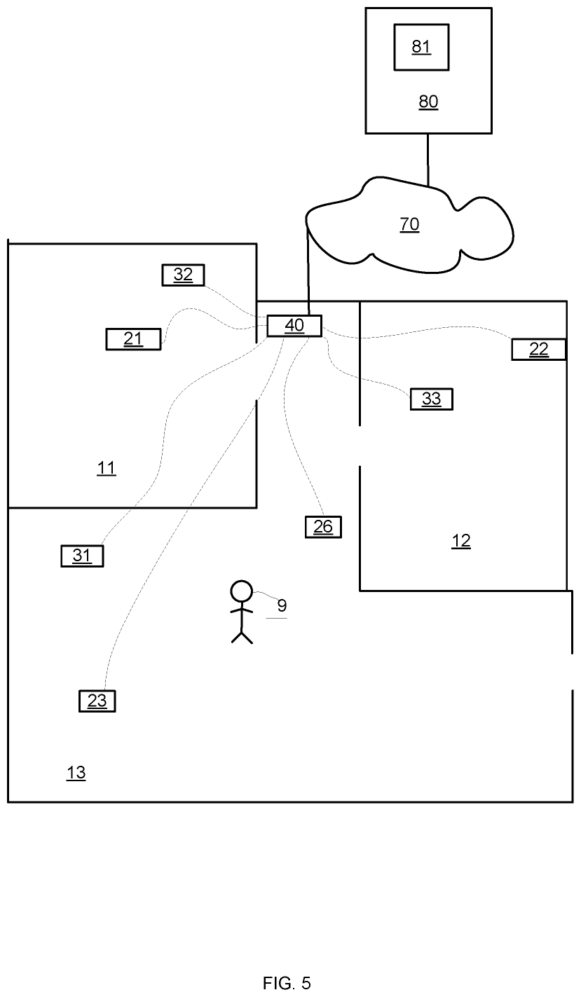

FIG. 5 illustrates a system that includes a local computer 40 that is coupled via network 70 to remote computer 80. Local computer 40 is coupled to various input devices 21, 22 and 23—and to output devices 31 and 33. Remote computer 80 stores (or is coupled to a storage device that stores) knowledge database 81.

In FIGS. 2-5 input devices 21, 22 and 23 are in rooms 11, 12, and 13 respectively and output device 31 is in room 13. In FIG. 5 output device 33 is in room 12. These are non-limiting examples. The number of input devices, the number of output devices and the locations of these devices may differ from those illustrated in FIGS. 2-5.

The certain location may include one or more sensors or systems for detecting the suspected burglary attempt—that may not be included in any of the systems of FIGS. 2-5. Alternatively, at least one out of the input devices, output devices, local computer 40 and/or remote computer 80 may participate in detecting the suspected attempt.

In the foregoing specification, the invention has been described with reference to specific examples of embodiments of the invention. It will, however, be evident that various modifications and changes may be made therein without departing from the broader spirit and scope of the invention as set forth in the appended claims.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also, for example, in one embodiment, the illustrated examples may be implemented as circuitry located on a single integrated circuit or within a same device. Alternatively, the examples may be implemented as any number of separate integrated circuits or separate devices interconnected with each other in a suitable manner. The integrated circuit may be a system on chip, a general-purpose processor, a signal processor, an FPGA, a neural network integrated circuit, and the like.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

We claim:

1. A method for burglary deterrent, the method comprising:
receiving or generating suspected burglary information regarding a suspected burglary;
selecting, by a computerized system, out of multiple burglary deterrent responses that differ from each other, a selected burglary deterrent response that comprises generating at least one deterring human perceivable signal; and
executing the selected burglary response, wherein the executing comprises generating the at least one human perceivable signal.

2. The method according to claim 1, wherein the suspected burglary information comprises burglar information about a burglar that is involved in the suspected burglary; and wherein the selecting is responsive to the burglar information.

3. The method according to claim 1, wherein the selecting is responsive to a gender of the burglar.

4. The method according to claim 1, wherein the executing of the selected burglary response comprises generating at least one message that comprises at least a part of the burglar information.

5. The method according to claim 1, wherein the executing of the selected burglary response comprises interacting with the burglar.

6. The method according to claim 1, comprising sensing a response of the burglar to the at least one human perceivable signal; and selecting another selected burglary deterrent response based on the response of the burglar.

7. The method according to claim 1, wherein the executing of the selected burglary response comprises generating messages in different languages.

8. The method according to claim 7, comprising:
monitoring a response of the burglar to the messages in different languages;
estimating which language of the multiple languages is understood by the burglar; and
generating additional messages at the language that is understood by the burglar.

9. The method according to claim 1, wherein the executing of the selected burglary response comprises interrogating the burglar.

10. The method according to claim 1, wherein the executing of the selected burglary response comprises displaying, on a display, an image of the burglar.

11. The method according to claim 1, wherein the executing of the selected burglary response comprises displaying, on a display, a video that shows a police car that approaches a location in which the suspected burglary occurs.

12. The method according to claim 1, wherein the executing of the selected burglary response comprises notifying a person of interest about the suspected burglary.

13. The method according to claim 1, wherein the executing of the selected burglary response comprises evaluating whether the burglar carries a weapon.

14. The method according to claim 1, wherein the selecting is responsive to information regarding previous burglaries.

15. The method according to claim 1, wherein the executing of the selected burglary response comprises playing annoying music.

16. The method according to claim 1 comprising sensing one or more burglar attributes.

17. The method according to claim 1 comprising storing the suspected burglary information in a remote computer.

18. A non-transitory computer program product that stores instructions for: receiving or generating suspected burglary information regarding a suspected burglary; selecting, by a computerized system, out of multiple burglary deterrent responses that differ from each other, a selected burglary deterrent response that comprises generating at least one deterring human perceivable signal; and executing the selected burglary response, wherein the executing comprises generating the at least one human perceivable signal.
